(19) United States
(12) Patent Application Publication
(10) Pub. No.: US 2020/0100470 A1
(43) Pub. Date: Apr. 2, 2020

(54) Pet Leash Attachment Apparatus

(71) Applicant: Patrick Cibotti, Boston, MA (US)

(72) Inventor: Patrick Cibotti, Boston, MA (US)

(21) Appl. No.: 16/149,097

(22) Filed: Oct. 1, 2018

(51) Int. Cl. A01K 27/00

(52) U.S. Cl. CPC A01K 27/005; A01K 27/003; A01K 27/001

(57) ABSTRACT

A pet leash attachment apparatus for easily securing a pet to an object includes a leash having a proximal end, a distal end, a top side, and a bottom side. A male attachment mechanism is coupled to the proximal end. A plurality of female attachment mechanisms is coupled to the top side of the leash and each of the plurality of female attachment mechanisms is selectively engageable with the male attachment mechanism to form a loop. A collar attachment mechanism is coupled to the distal end of the leash and is configured to attach to a pet collar.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to pet leashes and more particularly pertains to a new pet leash for easily securing a pet to an object.

### BRIEF SUMMARY OF THE INVENTION

An embodiment of the disclosure meets the needs presented above by generally comprising a leash having a proximal end, a distal end, a top side, and a bottom side. A male attachment mechanism is coupled to the proximal end. A plurality of female attachment mechanisms is coupled to the top side of the leash and each of the plurality of female attachment mechanisms is selectively engageable with the male attachment mechanism to form a loop. A collar attachment mechanism is coupled to the distal end of the leash and is configured to attach to a pet collar.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top plan view of a pet leash attachment apparatus according to an embodiment of the disclosure.

FIG. 2 is a side elevation view of an embodiment of the disclosure.

FIG. 3 is an isometric view of an embodiment of the disclosure.

FIG. 4 is a top plan view of an embodiment of the disclosure.

### DETAILED DESCRIPTION OF THE INVENTION

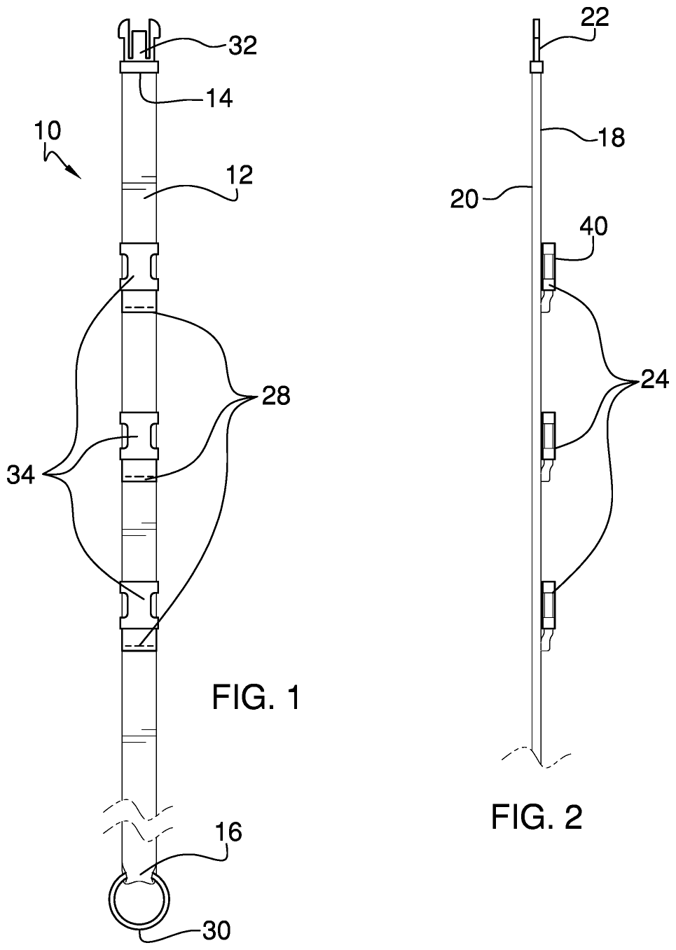

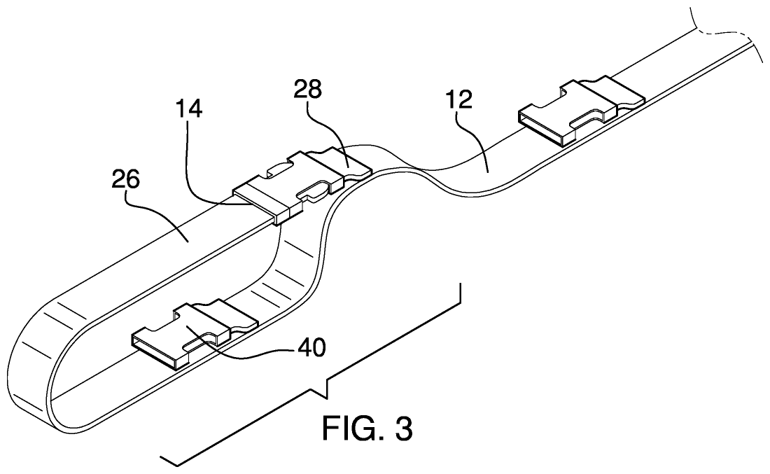

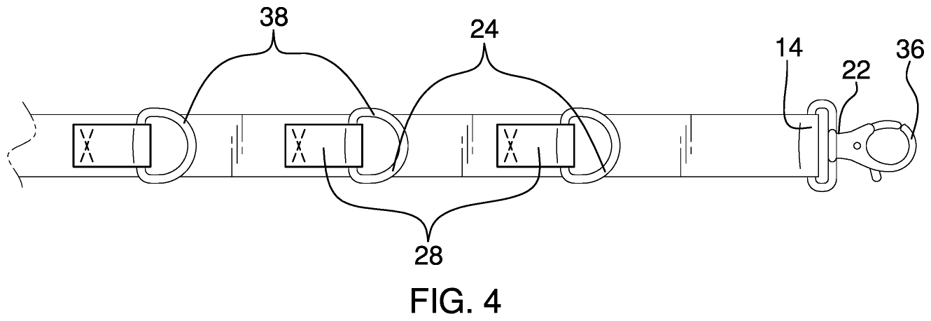

With reference now to the drawings, and in particular to FIGS. 1 through 4 thereof, a new pet leash embodying the principles and concepts of an embodiment of the disclosure and generally designated by the reference numeral 10 will be described.

As best illustrated in FIGS. 1 through 4, the pet leash attachment apparatus 10 generally comprises a leash 12 having a proximal end 14, a distal end 16, a top side 18, and a bottom side 20. A male attachment mechanism 22 is coupled to the proximal end 14 of the leash. A plurality of female attachment mechanisms 24 is coupled to the top side 14 of the leash, and each female attachment mechanism may be coupled a fixed distance from an adjacent female attachment mechanism of the plurality of female attachment mechanisms 24. Each of the plurality of female attachment mechanisms 24 is selectively engageable with the male attachment mechanism 22 to form a loop 26. A plurality of leaders 28 may be coupled to the plurality of female attachment mechanisms 24. Each leader of the plurality of leaders 28 is coupled to the top side 18 of the leash such that each of the plurality of female attachment mechanisms 24 pivots freely relative the leash 12. A collar attachment mechanism 30 is coupled to the distal end 16 of the leash and is configured to attach to a pet collar.

The male attachment mechanism 22 may be a male buckle 32 and the plurality of female attachment mechanisms 24 may be a plurality of female buckles 34. Alternatively, the male attachment mechanism 22 may be a clip 36 and the plurality of female attachment mechanisms 24 may be a plurality of D-rings 38.

In use, the collar attachment mechanism 30 is attached to a pet collar on a pet. When walking the pet, the male attachment mechanism 22 is engaged with a most proximal female attachment mechanism 40 of the plurality of female attachment mechanisms to form the loop 26 in its smallest form to be held in a user's hand. The pet may then be secured to an object by disengaging the male attachment mechanism 22 from the most proximal female attachment mechanism 40, wrapping it around the object, and then engaging the male attachment mechanism 22 with one of the plurality of female attachment mechanisms 24. The loop 26 formed by each female attachment mechanism of the plurality of female attachment mechanisms 24 is of a different size to fix the leash 12 to different sized objects including, but not limited to, sign posts, telephone poles, and trees.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pet leash attachment apparatus comprising:
a leash having a proximal end, a distal end, a top side, and a bottom side;
a male attachment mechanism coupled to the leash, the male attachment mechanism being coupled to the proximal end;
a plurality of female attachment mechanisms coupled to the leash, the plurality of female attachment mechanisms being coupled to the top side of the leash, each of the plurality of female attachment mechanisms being selectively engageable with the male attachment mechanism to form a loop; and
a collar attachment mechanism coupled to the leash, the collar attachment mechanism being attached to the distal end of the leash, wherein the collar attachment mechanism is configured to attach to a pet collar.

2. The pet leash attachment apparatus of claim 1 further comprising a plurality of leaders, the plurality of leaders being coupled to the plurality of female attachment mechanisms, each leader of the plurality of leaders being coupled to the top side of the leash such that each of the plurality of female attachment mechanisms pivots freely relative the leash.

3. The pet leash attachment apparatus of claim 1 further comprising the male attachment mechanism being a male buckle and each of the plurality of female attachment mechanisms being a female buckle.

4. The pet leash attachment apparatus of claim 2 further comprising the male attachment mechanism being a clip and each of the plurality of female attachment mechanisms being a D-ring.

5. The pet leash attachment apparatus of claim 1 further comprising each of the plurality of female attachment mechanisms being coupled a fixed distance from an adjacent female attachment mechanism of the plurality of female attachment mechanisms.

6. The pet leash attachment apparatus of claim 5 further comprising the plurality of female attachment mechanisms being three female attachment mechanisms.

7. A pet leash attachment apparatus comprising:
a leash having a proximal end, a distal end, a top side, and a bottom side;
a male buckle coupled to the leash, the male buckle being coupled to the proximal end;
a plurality of female buckles coupled to the leash, the plurality of female buckles being coupled to the top side of the leash a fixed distance from an adjacent female buckle of the plurality of female buckles, each of the plurality of female buckles being selectively engageable with the male buckle to form a loop;
a plurality of leaders coupled to the plurality of female buckles, each leader of the plurality of leaders being coupled to the top side of the leash such that each of the plurality of female buckles pivots freely relative the leash; and
a collar attachment mechanism coupled to the leash, the collar attachment mechanism being attached to the distal end of the leash, wherein the collar attachment mechanism is configured to attach to a pet collar.
